(19) United States
(12) Patent Application Publication
(10) Pub. No.: US 2026/0328251 A1
(43) Pub. Date: Oct. 22, 2026

(54) SCREW, STRUCTURE, TORQUE LIMITER, AND POWER TRANSMISSION MECHANISM

(71) Applicant: KANZAKI KOKYUKOKI MFG. CO., LTD., Amagasaki (JP)

(72) Inventor: Noriyuki Yamagishi, Amagasaki (JP)

(21) Appl. No.: 19/649,253

(22) Filed: Apr. 16, 2026

(30) Foreign Application Priority Data
Apr. 17, 2025 (JP) 2025-068085

(51) Int. Cl. F16D 7/02; F16B 31/02; F16B 33/02

(52) U.S. Cl. CPC F16D 7/024; F16B 31/027; F16B 33/02

(57) ABSTRACT

[Problem] To obtain a screw loosening prevention effect without damaging a screw, and to enable disassembly and re-tightening of the screw. [Solution] A screw fits into an inside of a cylindrical portion by rotating about a central axis. The screw includes: an outer peripheral face having a thread that enters a screw groove provided on an inner peripheral face of the cylindrical portion; a notch having a seat face and a support face that intersect each other and respectively intersect the outer peripheral face when viewed from an axial direction; a moving body movable along the support face; and an urging member that urges the moving body in a direction away from the seat face along the support face using the seat face as a fulcrum.

### CROSS REFERENCE TO RELATED APPLICATIONS

The present invention claims priority under 35 U.S.C. § 119 to Japanese Application No. 2025-068085, filed on Apr. 17, 2025, the entire contents of which being incorporated herein by reference.

### TECHNICAL FIELD

The present invention relates to a screw, a structure, a torque limiter, and a power transmission mechanism.

### BACKGROUND ART

Conventionally, a torque limiter that prevents excessive torque from being transmitted from an input side to an output side has been proposed. Among others, for example, Patent Document 1 discloses a torque limiter capable of adjusting an upper limit value of torque transmittable from an input side to an output side (hereinafter, also referred to as a “specified torque”). In the torque limiter of Patent Document 1, torque transmission from the input side to the output side is performed via a friction plate and a mating plate. The torque limiter is provided with a bolt for adjusting a pressing force between the friction plate and the mating plate. That is, the pressing force is adjusted by tightening or loosening the bolt. The specified torque is adjusted by adjusting the pressing force. Rotation of the bolt is prevented by a nut. This suppresses a change in the specified torque set by tightening the bolt.

### PRIOR ART DOCUMENT

### Patent Document

Patent Document 1: Japanese Unexamined Patent Application Publication No. 2020-41666

### SUMMARY OF INVENTION

### Technical Problem

In order to prevent loosening of a bolt due to vibration or the like, it is insufficient to simply mesh the bolt with a nut, and it is necessary to take some measures. Conventionally, for example, after meshing a bolt with a nut, a method such as physically crushing a thread of the bolt (or the nut) (for example, hitting the bolt from a side to crush the thread) has been generally performed. However, in the method of crushing the thread, disassembly of the bolt and the nut and re-tightening of the bolt become impossible or difficult. This means that disassembly, re-assembly, and re-adjustment of the specified torque of the torque limiter using the bolt become impossible or difficult. On the other hand, forcibly rotating the bolt from a state in which the thread is crushed may damage the bolt and make it impossible to reuse the bolt, which needs to be avoided.

Therefore, it is desired to realize a screw structure that can obtain an effect of preventing loosening of a screw such as a bolt without damaging the screw, and that enables disassembly and re-tightening of the screw. However, a screw having such a structure has not yet been proposed.

The present invention has been made to solve the above problems, and an object thereof is to provide a screw capable of obtaining a screw loosening prevention effect without damaging the screw and capable of performing disassembly and re-tightening of the screw, and a structure, a torque limiter, and a power transmission mechanism having the screw.

### Solution to Problem

A screw according to one aspect of the present invention is a screw that fits into an inside of a cylindrical portion by rotating about a central axis, and includes: an outer peripheral face having a thread that enters a screw groove provided on an inner peripheral face of the cylindrical portion; a notch having a seat face and a support face that intersect each other and respectively intersect the outer peripheral face when viewed from an axial direction; a moving body movable along the support face; and an urging member that urges the moving body in a direction away from the seat face along the support face using the seat face as a fulcrum.

A structure according to another aspect of the present invention includes the above-described screw and the cylindrical portion into which the screw is fitted.

A torque limiter, according to still another aspect of the present invention includes the above-described structure.

A power transmission mechanism according to still another aspect of the present invention includes an input mechanism into which power is inputted, and an output mechanism that outputs the power transmitted from the input mechanism, wherein the output mechanism has the above-described torque limiter.

### Advantageous Effects of Invention

The effect of preventing loosening of a screw can be obtained without damaging the screw, and disassembly and re-tightening of the screw can be performed.

### BRIEF DESCRIPTION OF DRAWINGS

FIG. 1 is a perspective view showing an appearance of a power transmission mechanism according to an embodiment of the present invention;

FIG. 2 is a perspective view showing an internal configuration of the power transmission mechanism when the power transmission mechanism is viewed from a shift mechanism side;

FIG. 3 is a perspective view showing an internal configuration of the power transmission mechanism when the power transmission mechanism is viewed from a side opposite to the shift mechanism;

FIG. 4 is a cross-sectional view showing a schematic configuration of a torque limiter included in the power transmission mechanism;

FIG. 5 is an exploded perspective view showing a part of the configuration of the torque limiter;

FIG. 6 is a perspective view showing a screw configuration of the torque limiter;

FIG. 7 is a front view of the screw when viewed from the other side in the axial direction;

FIG. 8 is an explanatory diagram geometrically showing each component of the screw;

FIG. 9 is an explanatory diagram geometrically showing each component of a screw of a comparative example;

FIG. 10 is a perspective view showing another configuration of the screw of the present embodiment including a moving body;

FIG. 11 is a perspective view showing still another configuration of the screw;

FIG. 12 is a perspective view showing another configuration of the moving body;

FIG. 13A is a perspective view showing still another configuration of the moving body;

FIG. 13B is a perspective view showing still another configuration of the moving body; and

FIG. 14 is a front view showing still another configuration of the screw.

### DESCRIPTION OF EMBODIMENTS

An embodiment of the present invention will be described below based on the drawings.

### 1. Configuration of Power Transmission Mechanism

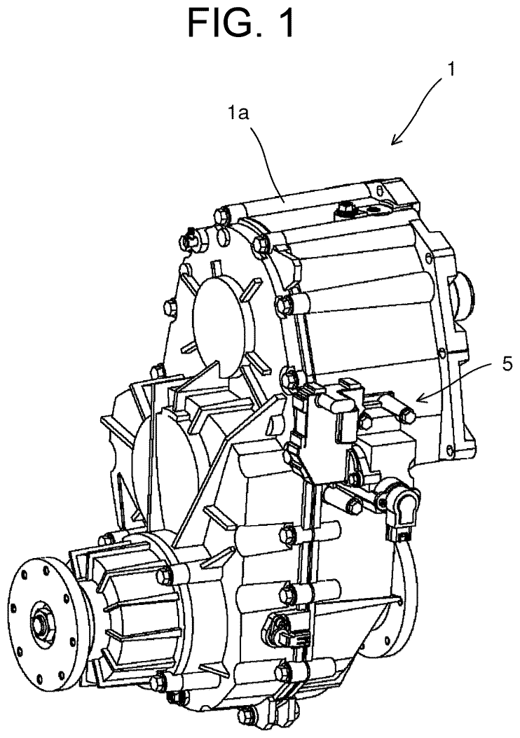

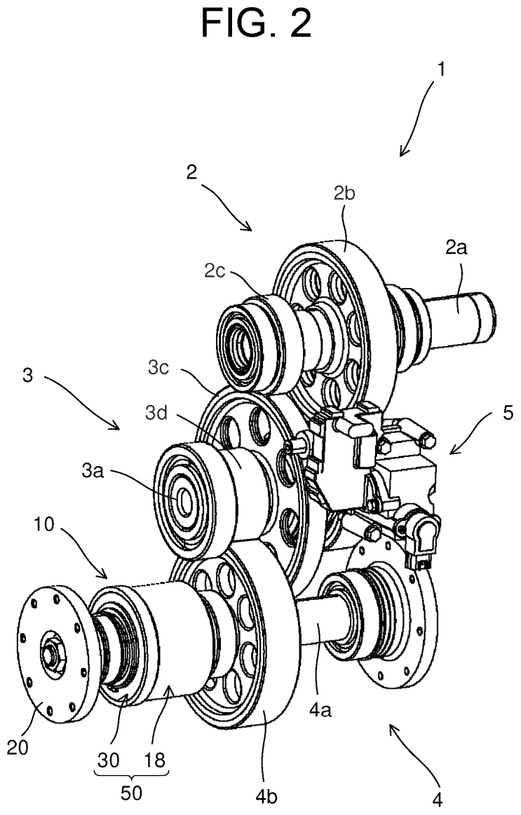

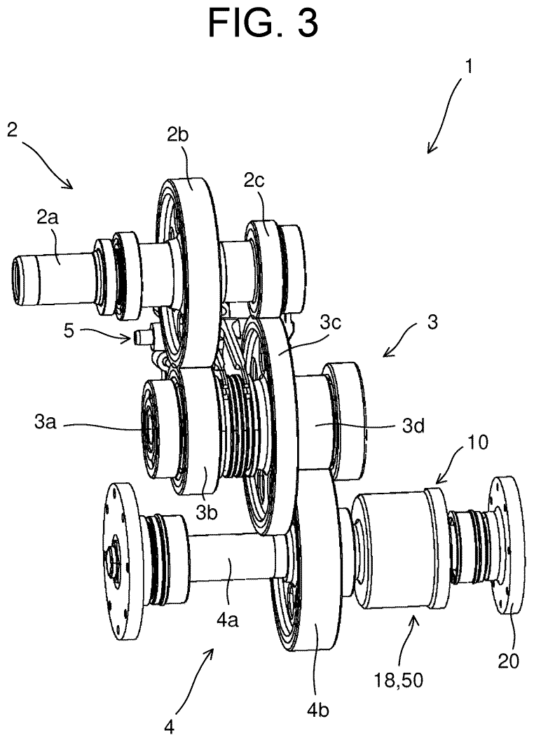

FIG. 1 is a perspective view showing an appearance of a power transmission mechanism 1 of the present embodiment. FIG. 2 is a perspective view showing an internal configuration of the power transmission mechanism 1 of FIG. 1 when viewed from a shift mechanism 5 side. FIG. 3 is a perspective view showing an internal configuration of the power transmission mechanism 1 of FIG. 1 when viewed from a side opposite to the shift mechanism 5. As shown in FIG. 2 and FIG. 3, the power transmission mechanism 1 includes an input mechanism 2, a speed reducer 3, an output mechanism 4, and a shift mechanism 5. The input mechanism 2, the speed reducer 3, and the output mechanism 4 are covered with an exterior cover 1a shown in FIG. 1. Further, the shift mechanism 5 is covered with the exterior cover 1a except for a part thereof. That is, a part of the shift mechanism 5 is located outside the exterior cover 1a.

The input mechanism 2 has an input shaft 2a, a first input gear 2b, and a second input gear 2c. Rotational power (hereinafter, simply referred to as “power”) from a drive source such as an engine is transmitted to the input shaft 2a. That is, power from the drive source is inputted to the input mechanism 2. The first input gear 2b and the second input gear 2c are coaxially attached to the input shaft 2a. The first input gear 2b has a larger diameter than the second input gear 2c. When the input shaft 2a rotates by the power, the first input gear 2b and the second input gear 2c also rotate simultaneously with the input shaft 2a as a rotation axis.

The speed reducer 3 has a reduction shaft 3a, a first reduction gear 3b, a second reduction gear 3c, and a third reduction gear 3d. The first reduction gear 3b and the second reduction gear 3c are provided so as to be rotatable (idle) with respect to the reduction shaft 3a. The first reduction gear 3b is arranged to mesh with the first input gear 2b. The first reduction gear 3b has a smaller diameter than the first input gear 2b and has a smaller diameter than the second reduction gear 3c. The second reduction gear 3c is arranged to mesh with the second input gear 2c. The second reduction gear 3c has a larger diameter than the second input gear 2c and has a larger diameter than the first reduction gear 3b.

The third reduction gear 3d is coaxially attached to the reduction shaft 3a. The third reduction gear 3d has a smaller diameter than the first reduction gear 3b. When the reduction shaft 3a rotates, the third reduction gear 3d also rotates simultaneously with the reduction shaft 3a as a rotation axis.

Here, ON and OFF of power transmission from the first reduction gear 3b or the second reduction gear 3c to the reduction shaft 3a is switched by a coupling member (not shown) moving along the reduction shaft 3a in accordance with the operation of the shift mechanism 5. For example, in a state where the coupling member mechanically couples the second reduction gear 3c and the reduction shaft 3a (a first speed state), rotational power of the second reduction gear 3c is transmitted to the reduction shaft 3a via the coupling member, and as a result, the reduction shaft 3a rotates. Then, the third reduction gear 3d attached to the reduction shaft 3a also rotates.

In a state where the coupling member mechanically couples the first reduction gear 3b and the reduction shaft 3a (a second speed state), rotational power of the first reduction gear 3b is transmitted to the reduction shaft 3a via the coupling member, and as a result, the reduction shaft 3a rotates. Then, the third reduction gear 3d attached to the reduction shaft 3a also rotates. However, from the relationship of the diameters of the first input gear 2b, the second input gear 2c, the first reduction gear 3b, and the second reduction gear 3c described above, the rotational speed of the third reduction gear 3d is faster than in the case of the first speed described above.

In a state where the coupling member releases the coupling between the second reduction gear 3c and the reduction shaft 3a and also releases the coupling between the first reduction gear 3b and the reduction shaft 3a (a neutral state), even if the first input gear 2b and the second input gear 2c rotate, the first reduction gear 3b and the second reduction gear 3c idle with respect to the reduction shaft 3a, and the reduction shaft 3a does not rotate. For this reason, the third reduction gear 3d attached to the reduction shaft 3a also does not rotate.

The output mechanism 4 has an output shaft 4a and an output gear 4b. The output shaft 4a is provided with a torque limiter 10 described later. That is, the output mechanism 4 has the torque limiter 10. The output gear 4b is coaxially attached to the output shaft 4a. The output gear 4b is arranged to mesh with the third reduction gear 3d of the speed reducer 3 described above. Therefore, when the third reduction gear 3d rotates, the output gear 4b rotates, and at the same time, the output shaft 4a also rotates. That is, power transmitted from the input mechanism 2 via the speed reducer 3 is inputted to the output mechanism 4.

The output gear 4b has a larger diameter than the third reduction gear 3d. For this reason, the rotational speed of the output gear 4b is reduced (that is, decelerated) more than the rotational speed of the third reduction gear 3d.

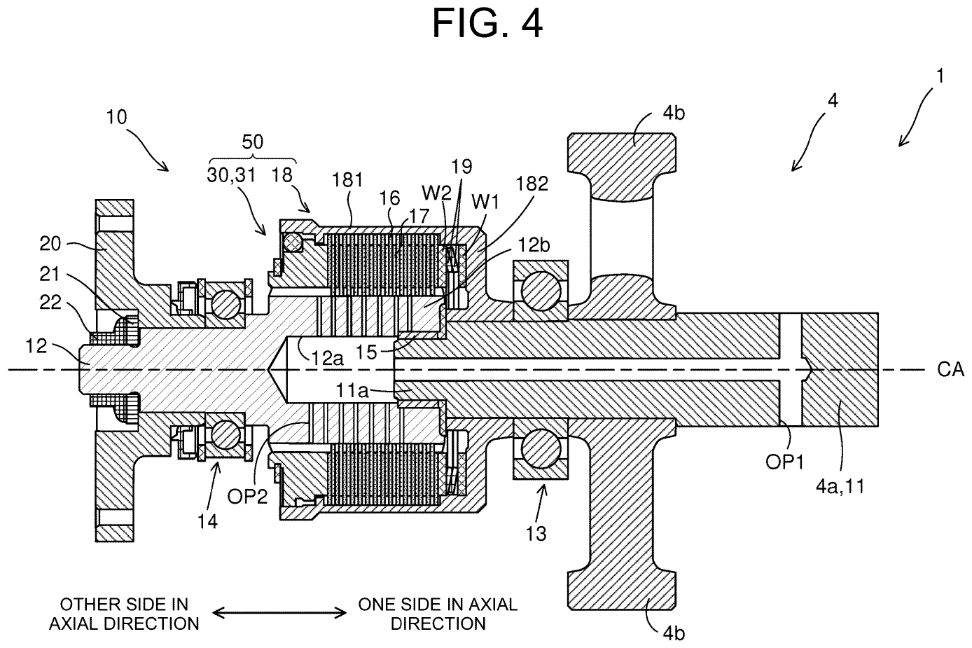

When the output shaft 4a rotates, an operation according to a rotational torque of the output shaft 4a is performed in the torque limiter 10. For example, if the rotational torque of the output shaft 4a is equal to or less than a specified value, the power transmitted to the output shaft 4a is transmitted to a downstream side via the torque limiter 10. That is, the power transmitted from the input mechanism 2 via the speed reducer 3 is outputted from the output mechanism 4. On the other hand, when the rotational torque of the output shaft 4a exceeds the specified value, the torque limiter 10 suppresses transmission of the power transmitted to the output shaft 4a to the downstream side. That is, power corresponding to a rotational torque equal to or less than the specified value is transmitted to the downstream side. This prevents breakage of parts located on the power transmission path due to excessive torque being applied to the parts. The specified value can be set by adjusting an axial position of a screw 31 (see FIG. 4, etc.) of the torque limiter 10, which will be described later. Details of the torque limiter 10 will be described below.

### 2. Configuration of Torque Limiter

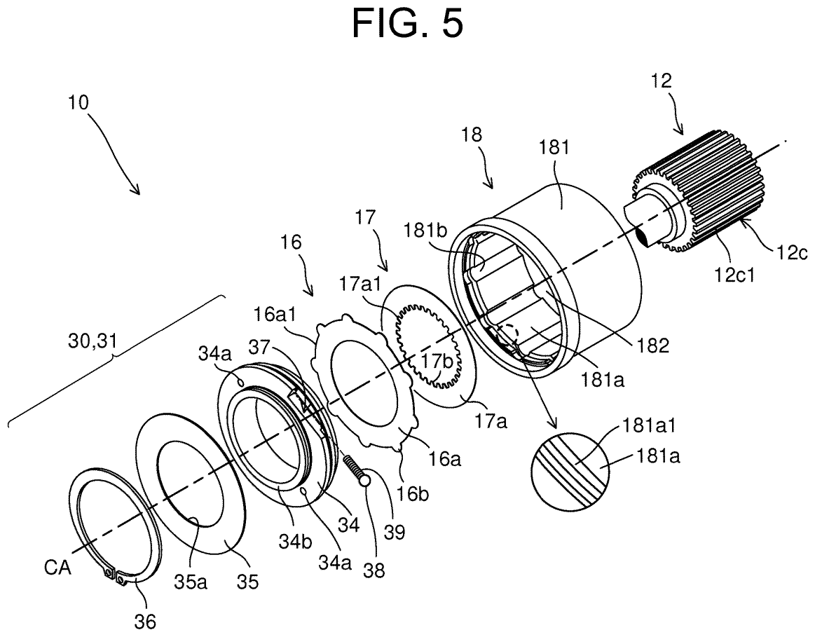

FIG. 4 is a cross-sectional view showing a schematic configuration of the torque limiter 10. FIG. 5 is an exploded perspective view showing a part of the configuration of the torque limiter 10. In FIG. 5, for convenience, only one first friction plate 16 and only one second friction plate 17 are shown.

Here, for convenience of explanation, a rotation axis when the output shaft 4a rotates is also referred to as a central axis CA. A direction in which the central axis CA extends is defined as an axial direction, and a direction perpendicular to the central axis CA is defined as a radial direction. A direction along an arc around the central axis CA is also referred to as a circumferential direction. Further, in the axial direction, a power input side is referred to as one side in the axial direction, and a power output side is referred to as the other side in the axial direction. In the radial direction, a direction approaching the central axis CA is defined as a radial inner side, and a direction away from the central axis CA is defined as a radial outer side.

As shown in FIG. 4 and FIG. 5, the torque limiter 10 includes an input shaft portion 11. The input shaft portion 11 is a shaft into which power is inputted and is composed of the output shaft 4a of the output mechanism 4 described above. Therefore, the output gear 4b is attached to the input shaft portion 11. When the output gear 4b rotates, the input shaft portion 11 also rotates at the same time. Therefore, it can be said that the power transmitted from the input mechanism 2 via the speed reducer 3 is inputted to the input shaft portion 11.

The input shaft portion 11 extends in the axial direction and is rotatably supported by a first bearing 13 inside the power transmission mechanism 1. Inside the input shaft portion 11, a first oil passage OP1 for circulating oil for lubrication is provided.

The torque limiter 10 further includes an output shaft portion 12. The output shaft portion 12 is arranged coaxially with the input shaft portion 11 and extends in the axial direction. The output shaft portion 12 is rotatably supported by a second bearing 14 inside the power transmission mechanism 1. Inside the output shaft portion 12, a second oil passage OP2 for circulating oil for lubrication is provided.

The output shaft portion 12 has a cavity portion 12a open on one side in the axial direction. A first end portion 11a located on the other side in the axial direction of the input shaft portion 11 enters the cavity portion 12a of the output shaft portion 12. In a state where the first end portion 11a enters the cavity portion 12a, the first end portion 11a faces a wall portion 12b on the radial outer side of the cavity portion 12a via a third bearing 15 in the radial direction. Thereby, the input shaft portion 11 can rotate relatively to the output shaft portion 12 including the wall portion 12b (for example, when the rotational torque exceeds the specified value). The third bearing 15 can be composed of, for example, a needle bearing, but may be composed of a bush or the like.

The torque limiter 10 further includes a first friction plate 16 and a second friction plate 17. The first friction plates 16 and the second friction plates 17 are alternately arranged in the axial direction. FIG. 4 shows a state in which two or more first friction plates 16 and two or more second friction plates 17 are respectively provided and are alternately arranged in the axial direction. Note that the number of the first friction plates 16 and the second friction plates 17 may be one each. That is, the torque limiter 10 may be configured to include at least one first friction plate 16 and at least one second friction plate 17.

The first friction plate 16 and the second friction plate 17 are configured by providing friction materials on both sides of an annular metal plate. One of the first friction plate 16 and the second friction plate 17 may be composed of a simple metal plate.

As shown in FIG. 5, the first friction plate 16 has an annular first plate portion 16a and a first engagement portion 16b. An inner diameter of the first plate portion 16a is larger than an outer diameter of the output shaft portion 12. The first engagement portion 16b is also a first protrusion portion provided so as to protrude radially outward from an outer peripheral portion 16a1 of the first plate portion 16a. A plurality of the first engagement portions 16b are provided at intervals in the circumferential direction on the outer peripheral portion 16a1 of the first plate portion 16a. Note that the plurality of first engagement portions 16b may be provided adjacently in the circumferential direction (so-called spline shape).

The second friction plate 17 has an annular second plate portion 17a and a second engagement portion 17b. An outer diameter of the second plate portion 17a is smaller than an inner diameter of a cylindrical portion 181 of a housing 18 described later. The second engagement portion 17b is also a second protrusion portion provided so as to protrude radially inward from an inner peripheral portion 17a1 of the second plate portion 17a. A plurality of the second engagement portions 17b are provided in the circumferential direction on the inner peripheral portion 17a1 of the second plate portion 17a. In the present embodiment, the plurality of second engagement portions 17b are provided adjacently in the circumferential direction on the inner peripheral portion 17a1 but may be provided at intervals in the circumferential direction.

The torque limiter 10 further includes a housing 18. The housing 18 is attached to the input shaft portion 11 by, for example, spline fitting, and rotates as the input shaft portion 11 rotates. The housing 18 has a cylindrical portion 181 and a bottom plate portion 182. The cylindrical portion 181 is arranged so as to extend in the axial direction and surrounds the central axis CA in the circumferential direction. The bottom plate portion 182 is coupled to an end portion on one side in the axial direction of the cylindrical portion 181. More specifically, the bottom plate portion 182 extends radially inward from the end portion on the one side in the axial direction of the cylindrical portion 181 and is attached to the input shaft portion 11 by, for example, spline fitting. The other side in the axial direction of the cylindrical portion 181 is open. A screw 31, which will be described later, is fitted into the cylindrical portion 181 from the other side in the axial direction.

As shown in FIG. 5, a first engaged portion 181b extending in the axial direction is provided on an inner peripheral face 181a of the cylindrical portion 181. The first engaged portion 181b is composed of, for example, a recessed portion, and a plurality of the first engaged portions 181b are provided at intervals in the circumferential direction on the inner peripheral face 181a. Note that the plurality of first engaged portions 181b may be provided adjacently in the circumferential direction on the inner peripheral face 181a. The first engaged portion 181b has a shape along the shape of the first engagement portion 16b of the first friction plate 16 described above. Therefore, in the housing 18, the first engagement portion 16b of the first friction plate 16 enters the first engaged portion 181b of the cylindrical portion 181. Thereby, the first friction plate 16 is held in the housing 18 so as to be movable in the axial direction along the first engaged portion 181b. In other words, the housing 18 holds the first friction plate 16 inside so as to be movable in the axial direction.

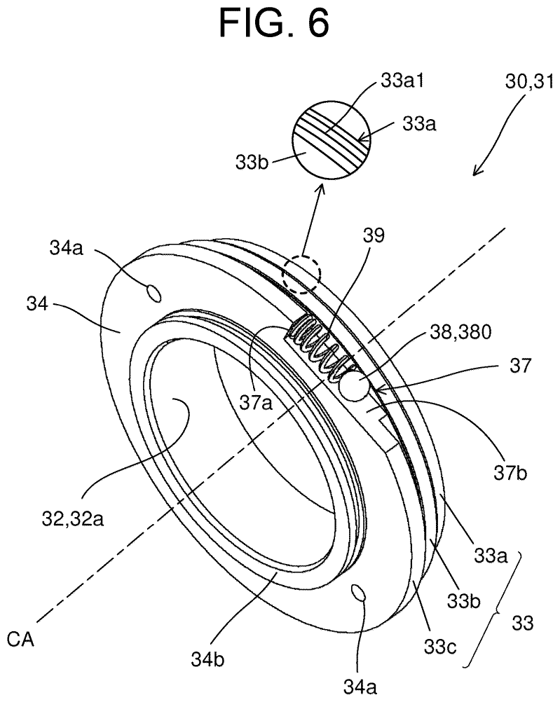

In the inner peripheral face 181a, a shape near the end portion on the other side in the axial direction is formed along a shape of an outer peripheral face 33 of the screw 31 (see FIG. 6). Further, a screw groove 181a1 is provided spirally near the end portion on the other side in the axial direction of the inner peripheral face 181a. By fitting a thread 33a1 of the screw 31 (see FIG. 6), which will be described later, into the screw groove 181a1 and rotating the screw 31, the screw 31 can be advanced and retreated in the axial direction to adjust the axial position of the screw 31.

As shown in FIG. 5, the output shaft portion 12 has a second engaged portion 12c1. The second engaged portion 12c1 is composed of a groove portion extending in the axial direction on a side face portion 12c that defines the outer peripheral face of the output shaft portion 12. A plurality of the second engaged portions 12cl are provided adjacently in the circumferential direction on the side face portion 12c but may be provided at intervals in the circumferential direction. The second engaged portion 12c1 has a shape along the shape of the second engagement portion 17b of the second friction plate 17. Therefore, in the housing 18, the second engagement portion 17b of the second friction plate 17 enters the second engaged portion 12c1 of the output shaft portion 12. Thereby, the second friction plate 17 is held by the output shaft portion 12 so as to be movable in the axial direction along the second engaged portion 12c1. In other words, the output shaft portion 12 holds the second friction plate 17 so as to be movable in the axial direction.

As shown in FIG. 4, the torque limiter 10 further includes a pressing member 19. The pressing member 19 is accommodated inside the housing 18. The pressing member 19 relatively presses one of the first friction plate 16 and the second friction plate 17 against the other in the axial direction. Such a pressing member 19 is composed of, for example, disc springs that elastically deform (expand and contract) in the axial direction. In the present embodiment, two pressing members 19 are arranged side by side in the axial direction. Note that the number of pressing members 19 is not particularly limited, and may be only one, or may be three or more.

In the housing 18, the pressing member 19 is arranged on one side in the axial direction with respect to the first friction plate 16 and the second friction plate 17. Further, a screw 31 described later is arranged on the other side in the axial direction with respect to the first friction plate 16 and the second friction plate 17. For this reason, the first friction plate 16 and the second friction plate 17 are sandwiched between the pressing member 19 and the screw 31 in the axial direction. Therefore, by the pressing member 19 pressing the first friction plate 16 and the second friction plate 17 from the one side in the axial direction toward the other side in the axial direction, one of the first friction plate 16 and the second friction plate 17 can be relatively pressed against the other in the axial direction.

The pressing member 19 is accommodated inside the housing 18 in a state of being sandwiched by two washers W1 and W2 in the axial direction. Thereby, damage to the housing 18 (particularly the bottom plate portion 182) and the friction plates (the first friction plate 16 or the second friction plate 17) by the pressing member 19 is reduced.

The torque limiter 10 further includes an adjustment member 30. The adjustment member 30 adjusts the pressing force of the first friction plate 16 and the second friction plate 17 by the pressing member 19 by defining the axial position inside the housing 18. Such an adjustment member 30 is composed of the screw 31. As described above, the first friction plate 16 and the second friction plate 17 are sandwiched between the pressing member 19 and the screw 31. Therefore, for example, by adjusting the position of the screw 31 to the one side in the axial direction or the other side in the axial direction, the strength of the pressing force of the first friction plate 16 and the second friction plate 17 by the pressing member 19 can be adjusted.

A flange 20 is provided at the end portion on the other side in the axial direction of the output shaft portion 12 described above. The flange 20 is fixed to the output shaft portion 12 by a nut 22 via a fixing washer 21. The power inputted to the output mechanism 4 is transmitted (outputted) from the torque limiter 10 to the outside via the flange 20.

Next, the operation of the torque limiter 10 having the above configuration will be described. As described above, the first friction plate 16 and the second friction plate 17 are pressed in the axial direction by the screw 31 and the pressing member 19. Therefore, power transmission (transmission of rotational torque) from the input shaft portion 11 to the output shaft portion 12 is performed via the housing 18, the first friction plate 16, and the second friction plate 17.

More specifically, the housing 18 is attached to the input shaft portion 11. Therefore, when the input shaft portion 11 rotates about the central axis CA, the housing 18 also rotates about the central axis CA.

The first engagement portion 16b of the first friction plate 16 enters the first engaged portion 181b of the housing 18 and is engaged in the circumferential direction. Therefore, when the housing 18 rotates about the central axis CA, the first friction plate 16 also rotates about the central axis CA. Further, the second engagement portion 17b of the second friction plate 17 enters the second engaged portion 12c1 of the output shaft portion 12 and is engaged in the circumferential direction. Therefore, when the second friction plate 17 rotates about the central axis CA, the output shaft portion 12 also rotates about the central axis CA.

Here, if the rotational torque of the input shaft portion 11 is equal to or less than a preset specified value, when the first friction plate 16 rotates, slippage does not occur in the second friction plate 17 pressed in the axial direction against the first friction plate 16. That is, when the first friction plate 16 rotates, the second friction plate 17 also rotates simultaneously (without slipping) due to the frictional force acting between the first friction plate 16 and the second friction plate 17. Therefore, in this case, power is transmitted from the input shaft portion 11 to the output shaft portion 12 via the first friction plate 16 and the second friction plate 17. Note that the specified value of the rotational torque described above corresponds to the pressing force by the pressing member 19 defined by the position of the screw 31.

On the other hand, when the rotational torque of the input shaft portion 11 exceeds the preset specified value, when the first friction plate 16 rotates, slippage occurs between the first friction plate 16 and the second friction plate 17. Therefore, in this case, the second friction plate 17 does not rotate simultaneously with the first friction plate 16. As a result, power transmission from the first friction plate 16 to the second friction plate 17 is suppressed. In other words, power transmission from the input shaft portion 11 to the output shaft portion 12 is suppressed.

### 3. Configuration of Screw

Next, details of the screw 31 described above will be described. FIG. 6 is a perspective view showing a configuration of the screw 31 as the adjustment member 30. The screw 31 fits into the inside of the cylindrical portion 181 of the housing 18 described above by rotating about the central axis CA. The screw 31 has a substantially cylindrical shape whose axial length is shorter than its radial length. Note that the axial length of the screw 31 may be equal to or greater than the radial length.

The screw 31 has an inner side face 32 as an inner peripheral face and an outer peripheral face 33. The inner side face 32 of the screw 31 forms a through hole 32a through which the output shaft portion 12 is inserted. The inner side face 32 of the screw 31 faces the side face portion 12c (see FIG. 5) of the output shaft portion 12 in the radial direction with a gap therebetween in the housing 18 (see FIG. 4).

The outer peripheral face 33 of the screw 31 is configured to include a plurality of outer peripheral faces having different diameters. Specifically, the outer peripheral face 33 includes a first outer peripheral face 33a, a second outer peripheral face 33b, and a third outer peripheral face 33c. The first outer peripheral face 33a, the second outer peripheral face 33b, and the third outer peripheral face 33c are arranged in this order from the one side in the axial direction toward the other side in the axial direction. The outer diameter of the first outer peripheral face 33a is smaller than the outer diameter of the second outer peripheral face 33b. The outer diameter of the second outer peripheral face 33b is smaller than the outer diameter of the third outer peripheral face 33c. That is, the outer diameter of the screw 31 changes in three steps. The first outer peripheral face 33a and the second outer peripheral face 33b are coupled by a face extending in the radial direction. The second outer peripheral face 33b and the third outer peripheral face 33c are coupled by a face extending in the radial direction.

Note that the shape of the screw 31 is not limited to a shape in which the outer diameter changes in three steps. For example, the outer diameter of the screw 31 may be constant, may change in two steps, or may change in four or more steps.

A thread 33a1 is spirally provided on the first outer peripheral face 33a. That is, the screw 31 has the thread 33a1 on the outer peripheral face 33. The thread 33a1 enters a screw groove 181a1 (see FIG. 5) provided on the inner peripheral face 181a of the cylindrical portion 181 of the housing 18.

The screw 31 further includes an end face 34. The end face 34 is a face that intersects the central axis CA. The end face 34 is coupled to the end portion on the other side in the axial direction of the outer peripheral face 33. Note that the end portion on the one side in the axial direction of the outer peripheral face 33 is coupled to another end face (not shown) that intersects the central axis CA.

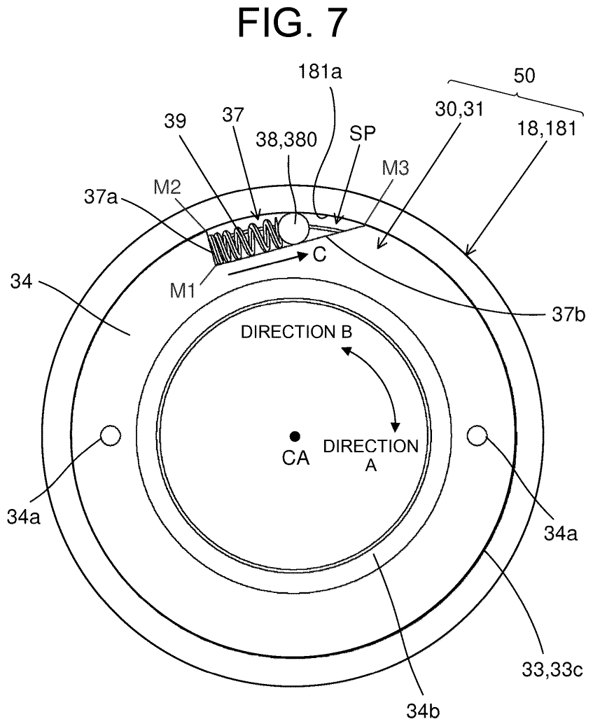

A jig insertion hole 34a is provided in the end face 34. The jig insertion holes 34a are provided at two positions that are rotationally symmetrical with respect to the central axis CA in the end face 34 (see also FIG. 7). When fitting the screw 31 into the inside of the cylindrical portion 181, a jig (not shown) is inserted into the jig insertion hole 34a and rotated around the central axis CA. Thereby, the screw 31 can be rotated around the central axis CA and fitted into the inside of the cylindrical portion 181.

A cylindrical protruding edge portion 34b is provided on the end face 34. The protruding edge portion 34b is provided so as to protrude from an inner peripheral side edge of the end face 34 toward the other side in the axial direction. An annular cover plate 35 (see FIG. 5) is fitted into the protruding edge portion 34b from the other side in the axial direction. The cover plate 35 is detachably arranged at a position facing the end face 34 in the axial direction, and covers a notch 37, a moving body 38, and an urging member 39, which will be described later, when viewed from the other side in the axial direction.

A retaining ring 36 (see FIG. 5) detachable from the protruding edge portion 34b is arranged on the other side in the axial direction with respect to the cover plate 35. The retaining ring 36 prevents the cover plate 35 from coming off toward the other side in the axial direction. Also, by removing the retaining ring 36, the cover plate 35 can be removed. That is, the cover plate 35 can be separated from the end face 34.

Note that it is not essential to provide the above-described jig insertion hole 34a in the end face 34. For example, the protruding edge portion 34b may be configured in a polygonal shape (for example, a hexagon) or an oval shape when viewed from the axial direction. In this case, the screw 31 can be rotated around the central axis CA by sandwiching the protruding edge portion 34b from the radial outer side with a jig.

In the present embodiment, the housing 18 and the screw 31 (adjustment member 30) described above are collectively referred to as a structure 50. Therefore, it can be said that the structure 50 has the screw 31 and the cylindrical portion 181 (of the housing 18) into which the screw 31 is fitted. Further, the torque limiter 10 (see FIG. 4 and FIG. 5) described above has the housing 18 and the screw 31. From this, it can be said that the torque limiter 10 includes the structure 50.

FIG. 7 is a front view of the screw 31 fitted inside the housing 18 when viewed from the other side in the axial direction. In FIG. 7, for convenience, illustration of the cover plate 35 and the retaining ring 36 shown in FIG. 5 is omitted. The screw 31 further includes a notch 37, a moving body 38, and an urging member 39.

The notch 37 has a shape obtained by cutting out a part of the cylindrical screw 31. Specifically, the notch 37 has a seat face 37a and a support face 37b. The seat face 37a and the support face 37b intersect each other and respectively intersect the outer peripheral face 33 when viewed from the axial direction. The seat face 37a and the support face 37b are composed of planes and intersect perpendicularly when viewed from the axial direction. Note that the seat face 37a and the support face 37b may intersect at an angle other than vertical (for example, an acute angle or an obtuse angle) when viewed from the axial direction. Furthermore, each of the seat face 37a and the support face 37b may be composed of a V-shaped face, an arcuate face (curved face), or the like when viewed from the axial direction.

Further, the seat face 37a may be composed of a V-shaped face, an arcuate curved face, or the like when viewed in a direction from a first intersection portion M1, which is an intersection portion with the support face 37b, toward a second intersection portion M2, which is an intersection portion with the outer peripheral face 33. Similarly, the support face 37b may be composed of a V-shaped face, an arcuate curved face, or the like when viewed in a direction from the first intersection portion M1, which is an intersection portion with the seat face 37a, toward a third intersection portion M3, which is an intersection portion with the outer peripheral face 33. That is, the seat face 37a and the support face 37b may be composed of faces other than a single plane.

The seat face 37a and the support face 37b extend to the other side in the axial direction and intersect the end face 34. Therefore, in a state where the cover plate 35 (see FIG. 5) is removed, the notch 37 including the seat face 37a and the support face 37b is exposed on the end face 34 side (the other side in the axial direction).

The moving body 38 is composed of, for example, a steel ball 380, and is provided so as to be movable along the support face 37b. The size (for example, diameter) of the moving body 38 is appropriately set to a size such that the moving body 38 fits between the support face 37b and the inner peripheral face 181a of the housing 18 when the screw 31 is fitted inside the housing 18. The moving body 38 is composed of a metal such as stainless steel, for example, but may be composed of a hard resin such as an acrylic resin.

The urging member 39 urges the moving body 38 in a direction away from the seat face 37a (direction C in FIG. 7) along the support face 37b using the seat face 37a as a fulcrum. Such an urging member 39 is composed of, for example, a coil spring, but may be composed of another member such as a plate spring. Both ends of the urging member 39 are not fixed to the seat face 37a and the moving body 38. For this reason, the urging member 39 is removable from the notch 37 together with the moving body 38. Note that the end portion of the urging member 39 may be fixed to the seat face 37a.

Next, the operation and effect of the configuration of the screw 31 described above will be described based on FIG. 4 to FIG. 7. When the screw 31 is rotated in one direction of the circumferential direction (for example, direction A in FIG. 7), the thread 33a1 (see FIG. 6) of the screw 31 enters the screw groove 181a1 (see FIG. 5) of the housing 18. Thereby, the screw 31 fits into the inside of the cylindrical portion 181.

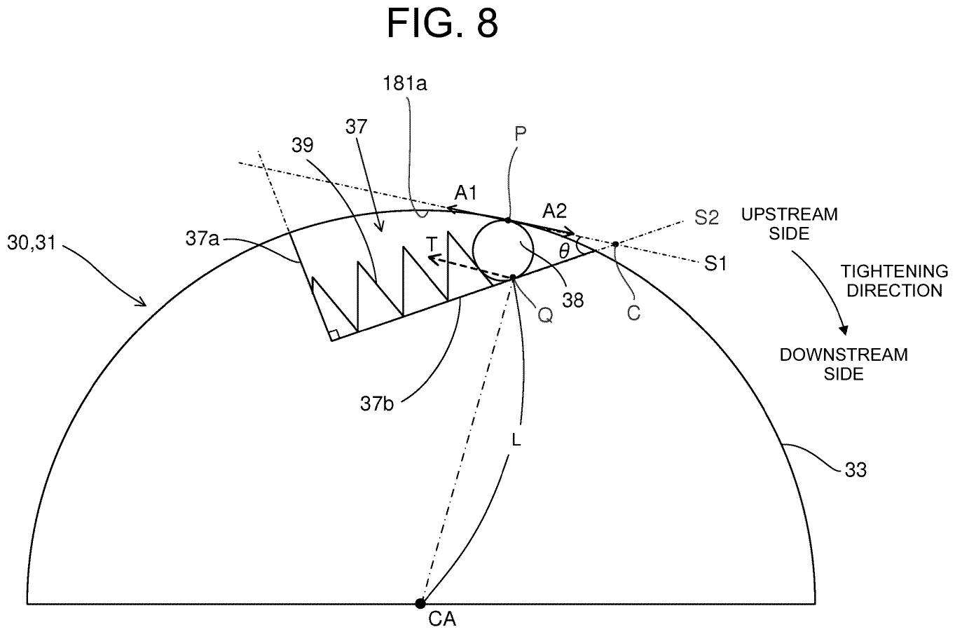

Here, when the screw 31 is rotated in the direction A, the moving body 38 supported by the support face 37b of the notch 37 rubs against the inner peripheral face 181a of the cylindrical portion 181 and receives a frictional force A1 (see FIG. 8). For this reason, even if the moving body 38 is urged in the direction C by the urging member 39, it becomes difficult for the moving body 38 to enter a tapered space SP (wedge-shaped space) between the inner peripheral face 181a of the cylindrical portion 181 and the support face 37b. As a result, rotation of the screw 31 in the direction A is not inhibited by the moving body 38, and the screw 31 can be turned and tightened in the direction A. That is, it is possible to advance the screw 31 to the one side in the axial direction in the housing 18 to increase the pressing force (specified value of the rotational torque) of the first friction plate 16 and the second friction plate 17.

On the other hand, regarding the rotation direction in which the screw 31 loosens (direction B in FIG. 7), because the moving body 38 is urged in the direction C by the urging member 39 and the moving body 38 rubs against the inner peripheral face 181a and receives a frictional force A2 (see FIG. 8) in a direction opposite to that when tightening the screw 31, the moving body 38 enters the tapered space SP and is further pressed toward the inner peripheral face 181a side by the support face 37b. Thereby, a so-called wedge effect is exhibited in which rotation of the screw 31 in the direction B is blocked by the moving body 38. Therefore, even when vibration is applied to the screw 31, for example, rotation of the screw 31 in the direction B, that is, loosening of the screw 31 is prevented. Therefore, as a measure for preventing loosening of the screw 31, for example, it is not necessary to adopt a method such as physically crushing the thread 33a1 (or the screw groove 181a1), which makes disassembly and re-tightening of the screw 31 difficult.

Further, the moving body 38 is movable along the support face 37b of the notch 37 and is not fixed to the support face 37b. For this reason, for example, it is possible to remove the moving body 38 from the notch 37. For example, by removing the cover plate 35 and the retaining ring 36 shown in FIG. 5, the moving body 38 (along with the urging member 39) can be easily removed from the notch 37. By removing the moving body 38, it is possible to intentionally turn the screw 31 in the direction B with respect to the cylindrical portion 181 to loosen it. Therefore, the screw 31 can be removed without damaging the cylindrical portion 181 and the screw 31 by the moving body 38. That is, even after the screw 31 is attached to the cylindrical portion 181, removal of the screw 31 (disassembly from the housing 18) can be performed.

In addition, as described above, since it is not necessary to physically crush the thread 33a1 or the screw groove 181a1 to prevent loosening of the screw 31, the screw 31 and the cylindrical portion 181 can be reused even after the screw 31 is removed from the cylindrical portion 181, and the position of the screw 31 can be re-adjusted (the position of the screw 31 in the axial direction with respect to the cylindrical portion 181 is re-adjusted).

That is, according to the configuration of the screw 31 of the present embodiment, the screw 31 loosening prevention effect can be obtained without damaging the screw 31, and disassembly and re-tightening of the screw 31 can be performed.

The structure 50 of the present embodiment includes the screw 31 described above and the housing 18 (particularly the cylindrical portion 181). In this case, in the structure 50 configured by fitting the screw 31 into the inside of the cylindrical portion 181, the following effects are obtained. That is, (1) loosening of the screw 31 caused by vibration can be prevented. (2) The screw 31 and the cylindrical portion 181 can be reused. (3) The position of the screw 31 can be re-adjusted.

The torque limiter 10 of the present embodiment includes the above-described structure 50. That is, the torque limiter 10 has the screw 31 and the cylindrical portion 181. In such a torque limiter 10, the following effects are obtained. That is, (1) similarly to the structure 50, loosening of the screw 31 caused by vibration can be prevented. (2) The torque limiter 10 can be disassembled by disassembling the screw 31 and the cylindrical portion 181. (3) Re-assembly of the torque limiter 10 by reusing the screw 31 and the cylindrical portion 181 can be performed. (4) The specified value of the rotational torque can be re-adjusted by adjusting the position of the screw 31.

In particular, in the torque limiter 10 that uses the first friction plate 16 and the second friction plate 17 (see FIG. 4, etc.) described above and cuts off power transmission from the input shaft portion 11 to the output shaft portion 12 when the rotational torque exceeds the specified value, the above-described effects are obtained.

Further, the output mechanism 4 (see FIG. 1 and FIG. 2) of the power transmission mechanism 1 of the present embodiment includes the torque limiter 10 described above. Therefore, in the power transmission mechanism 1 that transmits power from the input mechanism 2 to the output mechanism 4, the above-described effects of the present embodiment are obtained.

In the screw 31 of the present embodiment, if it is possible to take out the moving body 38 from the notch 37 as described above, it becomes possible to loosen the screw 31 by turning it in the direction B and eventually remove the screw 31 from the cylindrical portion 181. In order to enable removal of the moving body 38 from the notch 37, it is desirable that the moving body 38 is exposed from the end face 34 side (the other side in the axial direction) in a state where the cover plate 35 is removed. From the viewpoint of realizing such exposure of the moving body 38, it is desirable that the seat face 37a and the support face 37b of the notch 37 intersect the end face 34.

In the present embodiment, as shown in FIG. 6, the thread 33a1 is located on the one side in the axial direction with respect to the notch 37. In other words, in the axial direction, the thread 33a1 is located on a side opposite to the end face 34 with respect to the notch 37. By setting the axial positional relationship between the thread 33a1 and the end face 34 as described above, even in a state where the thread 33a1 has entered the screw groove 181a1 of the cylindrical portion 181 on the one side in the axial direction with respect to the notch 37, at least one of the moving body 38 and the urging member 39 can be exposed on the other side in the axial direction with respect to the notch 37, and the moving body 38 or the like can be taken out to the other side in the axial direction. In this respect, the above-described positional relationship is desirable.

During normal use of the screw 31 (when fitting the screw 31 into the cylindrical portion 181), by arranging the cover plate 35 facing the end face 34, it is possible to prevent the moving body 38 and the urging member 39 from falling out of the notch 37. Further, for example, when intentionally removing the screw 31 from the cylindrical portion 181, by removing the cover plate 35, the moving body 38 and the like can be removed from the notch 37, and the screw 31 can be turned in the loosening direction (direction B) to remove the screw 31. Thus, from the viewpoint of realizing removal of the moving body 38 and the like as necessary while preventing the moving body 38 and the like from falling out of the notch 37, it is desirable that the screw 31 includes the detachable cover plate 35.

### 4. Details of Conditions for Exhibiting Wedge Effect

FIG. 8 is an explanatory diagram geometrically showing each component of the screw 31 when the screw 31 is viewed from the other side in the axial direction. Details of the conditions for exhibiting the wedge effect described above will be described below.

In the following description, in the rotation direction when tightening the screw 31 (corresponding to direction A in FIG. 7), the starting point side is defined as “upstream side” and the end point side is defined as “downstream side”. Further, when viewed from the axial direction, a contact point between the moving body 38 and the inner peripheral face 181a is defined as a first contact point P, and a contact point between the moving body 38 and the support face 37b is defined as a second contact point Q. Furthermore, when viewed from the axial direction, a tangent line at the first contact point P is defined as a first tangent line S1, and a tangent line at the second contact point Q is defined as a second tangent line S2. Then, when viewed from the axial direction, a point where the first tangent line S1 and the second tangent line S2 intersect is defined as an intersection C. Further, an angle between the first tangent line S1 and the second tangent line S2 is defined as θ (°).

First, if the angle θ is 90° or more, it becomes difficult to form the tapered space SP shown in FIG. 7 between the inner peripheral face 181a and the support face 37b, and it becomes difficult to expect the wedge effect described above. For this reason, the angle θ needs to be an acute angle. In particular, it is expected that as the angle θ is smaller, the moving body 38 caught between the inner peripheral face 181a and the support face 37b becomes harder to come out against rotation of the screw 31 in the loosening direction, and the wedge effect increases.

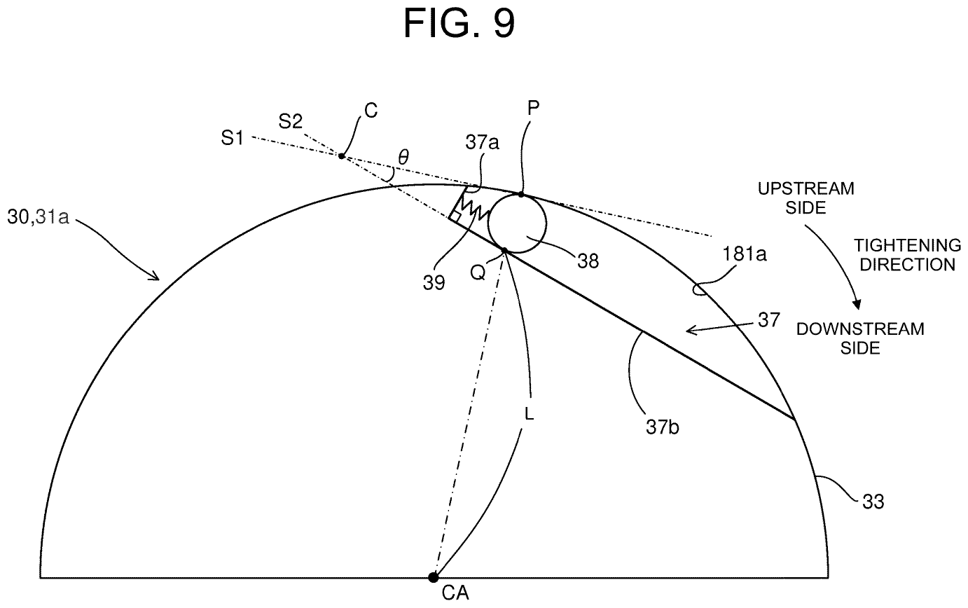

At this time, as shown in FIG. 9, when viewed from the axial direction, if the intersection C exists on the upstream side in the tightening direction with respect to the first contact point P (or the moving body 38), the tapered space SP sandwiched between the first tangent line S1 and the second tangent line S2 cannot be formed on the downstream side in the tightening direction with respect to the first contact point P. Therefore, as shown in FIG. 8, when viewed from the axial direction, the intersection C needs to be located on the downstream side in the tightening direction with respect to the first contact point P. Note that a screw 31a shown in FIG. 9 is a screw of a comparative example to be compared with the screw 31 of the present embodiment.

Summarizing the above, in order for the screw 31 of the present embodiment to exhibit the wedge effect, when viewed from the axial direction, it can be said that it is desirable that (1) the intersection C of the first tangent line S1 and the second tangent line S2 is located on the downstream side in the rotation direction for tightening the screw 31 with respect to the first contact point P (or the moving body 38), and (2) the angle θ between the first tangent line S1 and the second tangent line S2 is an acute angle.

As shown in FIG. 8, when viewed from the axial direction, a distance from the central axis CA to the second contact point Q is defined as L (m). When the angle θ is constant, as the moving body 38 is smaller (as the distance L is longer), the frictional force A1 becomes smaller with respect to a force T in the direction in which the screw 31 tends to loosen. For this reason, a force by which the moving body 38 tends to come out of the tapered space SP becomes smaller. That is, as the moving body 38 is smaller, the moving body 38 becomes harder to come out of the space SP, and the screw 31 becomes more resistant to loosening (the screw 31 becomes harder to loosen).

### 5. Modifications of Moving Body

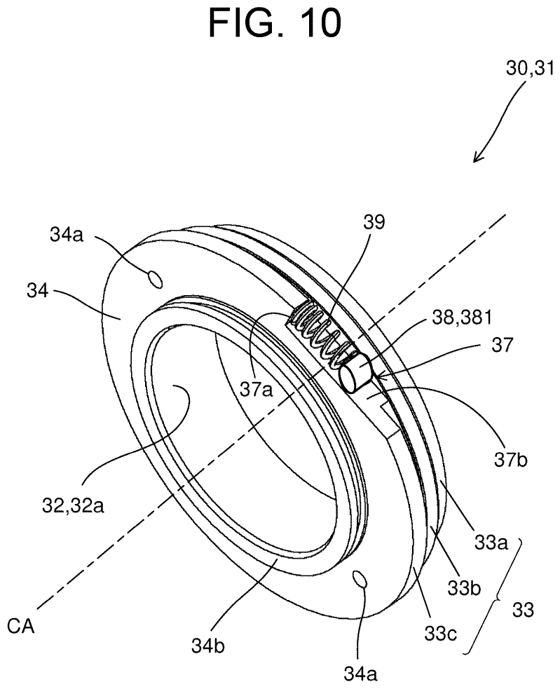

FIG. 10 is a perspective view showing another configuration of the screw 31. As shown in the figure, the moving body 38 included in the screw 31 may be composed of a cylinder 381. In this case, an outer peripheral face of the cylinder 381 is supported by the support face 37b and is urged in a direction along the support face 37b by the urging member 39.

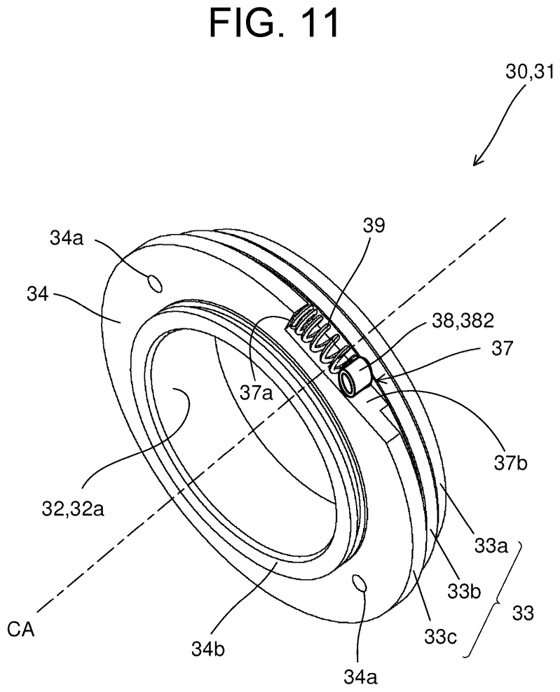

FIG. 11 is a perspective view showing still another configuration of the screw 31. As shown in the figure, the moving body 38 included in the screw 31 may be composed of a hollow cylinder 382. In this case, an outer peripheral face of the hollow cylinder 382 is supported by the support face 37b and is urged in a direction along the support face 37b by the urging member 39.

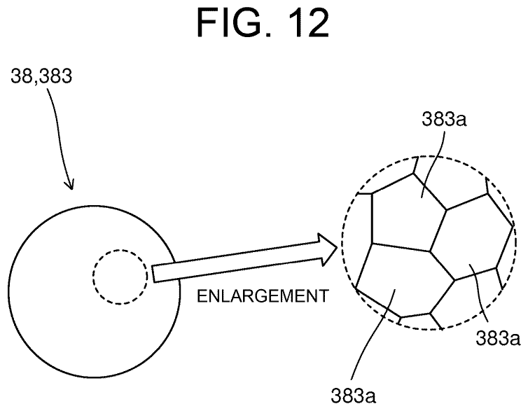

FIG. 12 is a perspective view showing another configuration of the moving body 38. As shown in the figure, the moving body 38 may be composed of a polyhedron 383. The polyhedron 383 is configured by connecting a plurality of faces 383a. Note that the face 383a may be a plane or a curved face. Further, the number of faces of the polyhedron 383 may be at least four. That is, the polyhedron 383 may be an N-faced polyhedron (N≥4) configured by connecting four or more faces 383a.

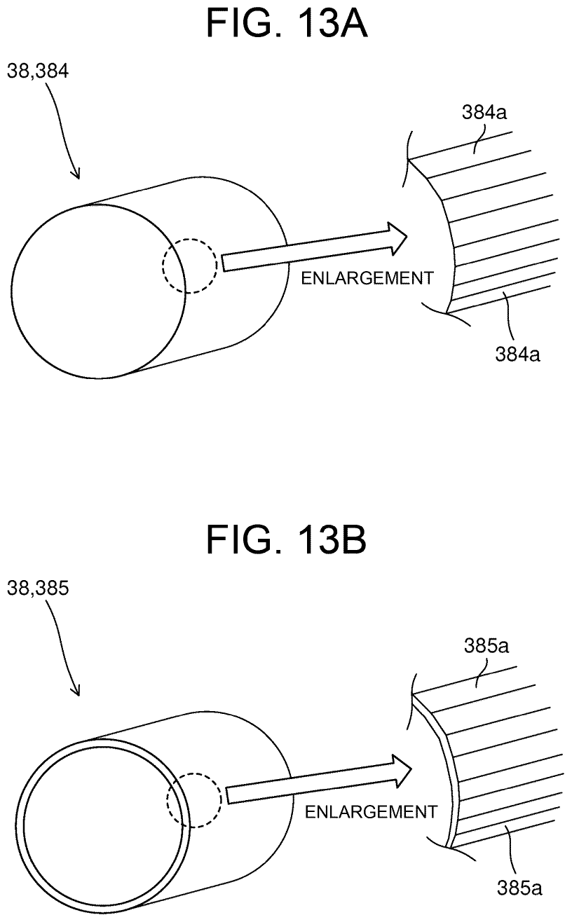

FIG. 13A is a perspective view showing still another configuration of the moving body 38. As shown in the figure, the moving body 38 may be composed of a columnar body 384 with a polygonal cross-section. The columnar body 384 is configured as a columnar shape as a whole by connecting a plurality of side faces 384a. Note that the side face 384a may be a plane or a curved face. Further, the number of side faces 384a may be at least three. That is, the columnar body 384 may be a columnar body with a polygonal cross-section configured by connecting three or more side faces 384a.

FIG. 13B is a perspective view showing still another configuration of the moving body 38. As shown in the figure, the moving body 38 may be composed of a tubular body 385 with a polygonal cross-section. The tubular body 385 is configured as a tubular shape as a whole by connecting a plurality of side faces 385a. Note that the side face 385a may be a plane or a curved face. Further, the number of side faces 385a may be at least three. That is, the tubular body 385 may be a tubular body with a polygonal cross-section configured by connecting three or more side faces 385a.

From the viewpoint of moving the moving body 38 along the support face 37b to obtain the loosening prevention effect for the screw 31, the moving body 38 of the present embodiment may be any of a sphere (for example, steel ball 380), a cylinder 381, a hollow cylinder 382, a polyhedron 383, a columnar body 384 with a polygonal cross-section, and a tubular body 385 with a polygonal cross-section.

### 6. Modifications of Screw

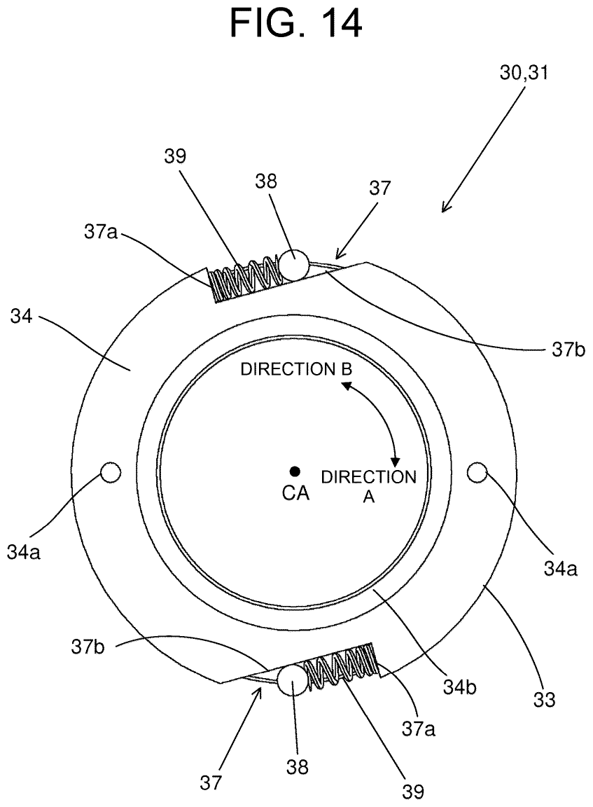

FIG. 14 is a front view showing still another configuration of the screw 31.

As shown in the figure, the screw 31 may have a plurality of notches 37, moving bodies 38, and urging members 39 in the circumferential direction. That is, a plurality of the notches 37 described above and moving bodies 38 and urging members 39 arranged in the notches 37 may be provided in the circumferential direction. FIG. 14 shows a configuration in which two notches 37, two moving bodies 38, and two urging members 39 are provided in the circumferential direction, but three or more of these may be provided in the circumferential direction. As shown in FIG. 14, the plurality of notches 37, moving bodies 38, and urging members 39 are provided at positions that are rotationally symmetrical in the circumferential direction (positions that are at equal intervals in the circumferential direction), but may be provided at rotationally asymmetrical positions.

In order to enhance the loosening prevention effect for the screw 31, the loosening prevention effect for the screw 31 may be obtained at a plurality of locations in the circumferential direction. For that purpose, it is desirable to provide a plurality of the notches 37 in the circumferential direction and arrange the moving body 38 and the urging member 39 in each notch 37.

### 7. Supplement

In the present embodiment, the screw 31 and the structure 50 applied to the torque limiter 10 have been described, but the screw 31 and the structure 50 can also be applied to mechanical products other than the torque limiter 10.

Further, the structure 50 can also be used alone as an assembly part for fixing or separating two members (the screw 31 and the cylindrical portion 181).

### 8. Supplementary Notes

The screw 31, the structure 50, the torque limiter 10, and the power transmission mechanism 1 described in the present embodiment can also be expressed as follows.

The screw according to Supplementary Note (1) is a screw that fits into an inside of a cylindrical portion by rotating about a central axis, and includes: an outer peripheral face having a thread that enters a screw groove provided on an inner peripheral face of the cylindrical portion; a notch having a seat face and a support face that intersect each other and respectively intersect the outer peripheral face when viewed from an axial direction; a moving body movable along the support face; and an urging member that urges the moving body in a direction away from the seat face along the support face using the seat face as a fulcrum.

The screw according to Supplementary Note (2) is the screw according to Supplementary Note (1), in which the screw further includes an end face that intersects the central axis, and the seat face and the support face intersect the end face.

The screw according to Supplementary Note (3) is the screw according to Supplementary Note (2), in which in an axial direction, the thread is located on a side opposite to the end face with respect to the notch.

The screw according to Supplementary Note (4) is the screw according to Supplementary Note (2) or (3), in which the screw further includes a cover plate detachably arranged at a position facing the end face in the axial direction and covering the moving body and the urging member when viewed from the axial direction.

The screw according to Supplementary Note (5) is the screw according to any one of Supplementary Notes (1) to (4), in which when viewed from the axial direction, a contact point between the moving body and the inner peripheral face is defined as a first contact point, a contact point between the moving body and the support face is defined as a second contact point, a tangent line at the first contact point is defined as a first tangent line, and a tangent line at the second contact point is defined as a second tangent line, when viewed from the axial direction: the intersection of the first tangent line and the second tangent line is located on a downstream side in a rotation direction for tightening the screw with respect to the first contact point; and an angle between the first tangent line and the second tangent line is an acute angle.

The screw according to Supplementary Note (6) is the screw according to any one of Supplementary Notes (1) to (5), in which the moving body is any of a sphere, a cylinder, a hollow cylinder, a polyhedron, a columnar body with a polygonal cross-section, and a tubular body with a polygonal cross-section.

The screw according to Supplementary Note (7) is the screw according to any one of Supplementary Notes (1) to (6), in which a plurality of the notches and a plurality of the moving bodies and the urging members arranged in the notches are provided in a circumferential direction.

The structure according to Supplementary Note (8) includes: the screw according to any one of Supplementary Notes (1) to (7); and the cylindrical portion into which the screw is fitted.

The torque limiter according to Supplementary Note (9) includes the structure according to Supplementary Note (8).

The torque limiter according to Supplementary Note (10) is the torque limiter according to Supplementary Note (9), including: a first friction plate and a second friction plate alternately arranged in an axial direction; an input shaft portion extending in the axial direction; a housing that rotates as the input shaft portion rotates and holds the first friction plate inside so as to be movable in the axial direction; an output shaft portion arranged coaxially with the input shaft portion and holding the second friction plate so as to be movable in the axial direction; a pressing member accommodated inside the housing and relatively pressing one of the first friction plate and the second friction plate against the other in the axial direction; and an adjustment member that adjusts a pressing force of the first friction plate and the second friction plate by the pressing member by defining an axial position inside the housing, wherein the adjustment member is composed of the screw of the structure, and the housing has the cylindrical portion.

The power transmission mechanism according to Supplementary Note (11) includes: an input mechanism into which power is inputted; and an output mechanism that outputs the power transmitted from the input mechanism, wherein the output mechanism has the torque limiter according to Supplementary Note (9) or (10).

Although the embodiments of the present invention have been described above, the scope of the present invention is not limited thereto and can be implemented with extensions or modifications without departing from the gist of the invention.

### INDUSTRIAL APPLICABILITY

The screw and the structure of the present invention can be used, for example, for a torque limiter provided in a power transmission mechanism.

### REFERENCE SIGNS LIST

1 . . . Power transmission mechanism
2 . . . Input mechanism
4 . . . Output mechanism
4a . . . Output shaft (input shaft portion of torque limiter)
10 . . . Torque limiter
11 . . . Input shaft portion
12 . . . Output shaft portion
16 . . . First friction plate
17 . . . Second friction plate
18 . . . Housing
19 . . . Pressing member
30 . . . Adjustment member
31 . . . Screw
33 . . . Outer peripheral face
33a1 . . . Thread
34 . . . End face
35 . . . Cover plate
37 . . . Notch
37a . . . Seat face
37b . . . Support face
38 . . . Moving body
39 . . . Urging member
50 . . . Structure
181 . . . Cylindrical portion
181a . . . Inner peripheral face
181a1 . . . Screw groove
380 . . . Steel ball
381 . . . Cylinder
382 . . . Hollow cylinder
383 . . . Polyhedron
384 . . . Columnar body
385 . . . Tubular body
CA . . . Central axis
C . . . Intersection
P . . . First contact point
Q . . . Second contact point
S1 . . . First tangent line
S2 . . . Second tangent line
θ . . . Angle

1. A screw that fits into an inside of a cylindrical portion by rotating about a central axis, comprising:
an outer peripheral face having a thread that enters a screw groove provided on an inner peripheral face of the cylindrical portion;
a notch having a seat face and a support face that intersect each other and respectively intersect the outer peripheral face when viewed from an axial direction;
a moving body movable along the support face; and
an urging member that urges the moving body in a direction away from the seat face along the support face using the seat face as a fulcrum.

2. The screw according to claim 1, further comprising an end face that intersects the central axis, wherein the seat face and the support face intersect the end face.

3. The screw according to claim 2, wherein in the axial direction, the thread is located on a side opposite to the end face with respect to the notch.

4. The screw according to claim 2, further comprising a cover plate detachably arranged at a position facing the end face in the axial direction and covering the moving body and the urging member when viewed from the axial direction.

5. The screw according to claim 1, wherein when viewed from the axial direction, a contact point between the moving body and the inner peripheral face is defined as a first contact point, a contact point between the moving body and the support face is defined as a second contact point, a tangent line at the first contact point is defined as a first tangent line, and a tangent line at the second contact point is defined as a second tangent line,
when viewed from the axial direction:
an intersection of the first tangent line and the second tangent line is located on a downstream side in a rotation direction for tightening the screw with respect to the first contact point; and
an angle between the first tangent line and the second tangent line is an acute angle.

6. The screw according to claim 1, wherein the moving body is any of a sphere, a cylinder, a hollow cylinder, a polyhedron, a columnar body with a polygonal cross-section, and a tubular body with a polygonal cross-section.

7. The screw according to claim 1, wherein a plurality of the notches and a plurality of the moving bodies and the urging members arranged in the notches are provided in a circumferential direction.

8. A structure comprising the screw according to claim 1 and the cylindrical portion into which the screw is fitted.

9. A torque limiter comprising the structure according to claim 8.

10. The torque limiter according to claim 9, comprising:
a first friction plate and a second friction plate alternately arranged in the axial direction;
an input shaft portion extending in the axial direction;
a housing that rotates as the input shaft portion rotates and holds the first friction plate inside so as to be movable in the axial direction;
an output shaft portion arranged coaxially with the input shaft portion and holding the second friction plate so as to be movable in the axial direction;
a pressing member accommodated inside the housing and relatively pressing one of the first friction plate and the second friction plate against the other in the axial direction; and
an adjustment member that adjusts a pressing force of the first friction plate and the second friction plate by the pressing member by defining an axial position inside the housing,
wherein the adjustment member is composed of the screw of the structure, and
the housing has the cylindrical portion.

11. A power transmission mechanism comprising:
an input mechanism into which power is inputted; and
an output mechanism that outputs the power transmitted from the input mechanism,
wherein the output mechanism has the torque limiter according to claim 9.
